(19) United States
(12) Patent Application Publication
(10) Pub. No.: US 2007/0031066 A1
(43) Pub. Date: Feb. 8, 2007

(54) Device and method for image searching, and recording medium in which image searching program is recorded

(76) Inventor: Kenji Nakano, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/498,556

(22) Filed: Aug. 3, 2006

(30) Foreign Application Priority Data
Aug. 4, 2005 (JP) 2005-226724

(51) Int. Cl. G06K 9/54; G06K 9/46

(52) U.S. Cl. 382/305; 382/190

(57) ABSTRACT

There is disclosed, in an image searching device, a technology in which a person's facial portion is extracted from an original image, and an index image including this facial portion is produced and displayed. In consequence, the person's facial portion in the image can easily be distinguished. Furthermore, as an arbitrary option, there is also disclosed a technology for editing an original image so that a person selected from an index image is positioned in the center to display the original image.

### CROSS-REFERENCE TO RELATED APPLICATION

This application is based upon and claims the benefit of priority from prior Japanese Patent Application No. 2005-226724, filed on Aug. 4, 2005, the entire contents of which are incorporated herein by reference.

### BACKGROUND OF THE INVENTION

1. Field of the Invention

The present invention relates to a technology capable of facilitating visual recognition of a characteristic portion without impairing an original image in a case where a specific object in an image is searched.

2. Description of the Related Art

In a case where an image in which a specific person is photographed is to be extracted from a large amount of images, since the person's face photographed in the image is small, visibility is not satisfactory, and much trouble is taken in searching for the specific person in many cases.

To solve the problem, in Japanese Patent Application Laid-Open No. 2004-326555, a technology is disclosed in which an only characteristic region in the image is relatively enlarged in display magnification and is synthesized with the reduced image of the image and displayed.

However, in the method described in Japanese Patent Application Laid-Open No. 2004-326555, the impression of the whole image to be displayed is different from an original image, and this impairs the image quality. Further, in a case where the characteristic region is disposed adjacent to another characteristic region, the characteristic regions may be superimposed on each other, and a part of the enlarged image is sometimes hidden.

### BRIEF SUMMARY OF THE INVENTION

An image searching device of the present invention recognizes and extracts a person's facial portion from an original image of one index image selected from a displayed list of index images, and produces the index image including this facial portion (face index) and displays the face index. This facilitates identification of the face.

One example of a constitution of the image searching method of the present application will hereinafter be described. The device comprises: an image storage section which can store a plurality of images; an index producing section which produces an index image of an original image stored in the image storage section; an index display section which displays the produced index image of the original image in a display; an index selecting section which allows a user to select a desired index image from the index images displayed in the display; a face extracting section which extracts a person's facial portion from the original image corresponding to the index image selected by the index selecting section; a face index producing section to produce a face index image which is the index image including the facial portion extracted by the face extracting section; and a face index display section which displays in the display the face index image produced by the face index producing section.

The present application can be understood as the invention of an image searching method and the invention of a recording medium in which an image searching program is recorded.

According to the present invention, the person's facial portion can easily be recognized visually without impairing the whole original image. In consequence, an efficiency of searching for a desired person can be enhanced.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is an explanatory view of an image searching method in one embodiment of the present invention;

FIG. 2 is an explanatory view of a searching method based on an extracted image;

FIG. 3 is a block diagram showing a constitution of a searching device for executing a searching operation;

FIG. 4 is a diagram showing a searching screen;

FIG. 5 is a flow chart showing a schematic procedure of search processing;

FIG. 6 is a flow chart showing a schematic procedure of search processing in a variation; and

FIG. 7 is a flow chart showing the schematic procedure of the search processing in the variation.

### DETAILED DESCRIPTION OF THE PREFERRED EMBODIMENTS

A preferred embodiment of the invention is described below with reference to the accompanying drawings.

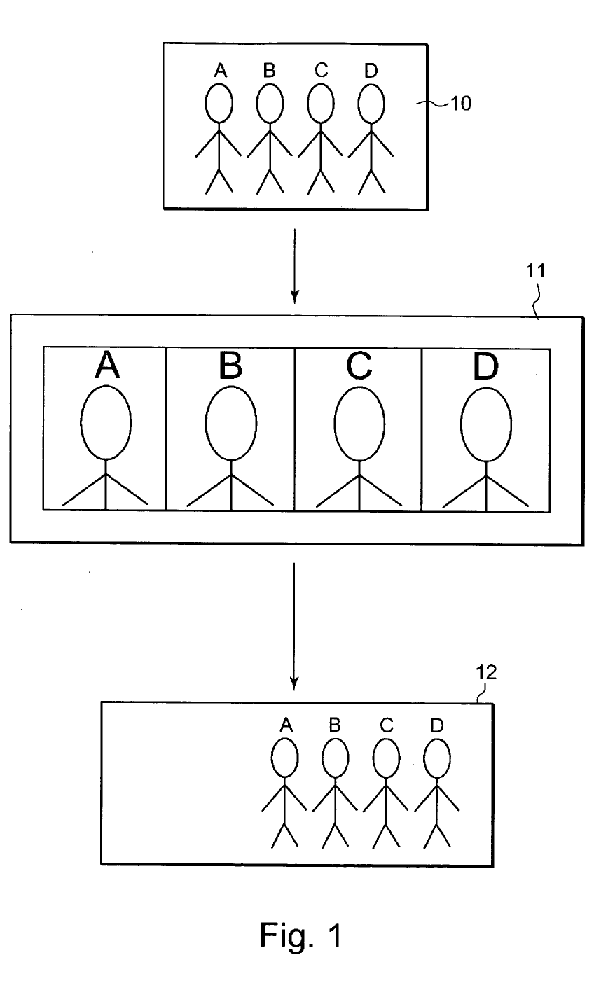

FIG. 1 is an explanatory view of an outline of an image searching method in one embodiment of the present invention.

In a reduced image (index image) 10 of an original image, a state is photographed in which a plurality of persons gather together. When a user selects this index image 10 to perform a predetermined operation, an index image (face index) arrangement 11 is displayed in which only facial portions of the persons are enlarged.

As the predetermined operation, there is, for example, an operation of selecting the index image 10 with a pointing device and click the image. As a method of extracting and enlarging the only person's facial portion, there is, for example, a method of extracting a face from the original image of the index image 10 by use of a known feature value of the image, and resizing the extracted face into a size of the index image. Otherwise, the facial portion may beforehand be extracted from the original image, and the index image of the extracted facial portion may be associated with the original image, and recorded.

When the user confirms the person being searched from these face index images 11, and selects the face index image of the person, an original image 12 is displayed. In a case where the original image 12 is displayed, a position of the person is shifted to the center of the image. In, for example, FIG. 1, when the user selects a person A from the displayed face index image list 11, the person A is positioned and displayed in the center of the extracted original image 12.

In this manner, since the arrangement 11 of the index images of the persons' facial portions (face indexes) is displayed, the user can easily search for the image in which the specific person is photographed.

Moreover, as a variation of this method, the index image of the face produced once can be stored beforehand in a searching process, and accordingly a subsequent search processing time can be shortened.

That is, in the method of the variation, the index image of the original image and the index images of the plurality of extracted facial portions are associated with the original image and stored. Moreover, the index images of the facial portions (face indexes) are displayed instead of the index image of the original image.

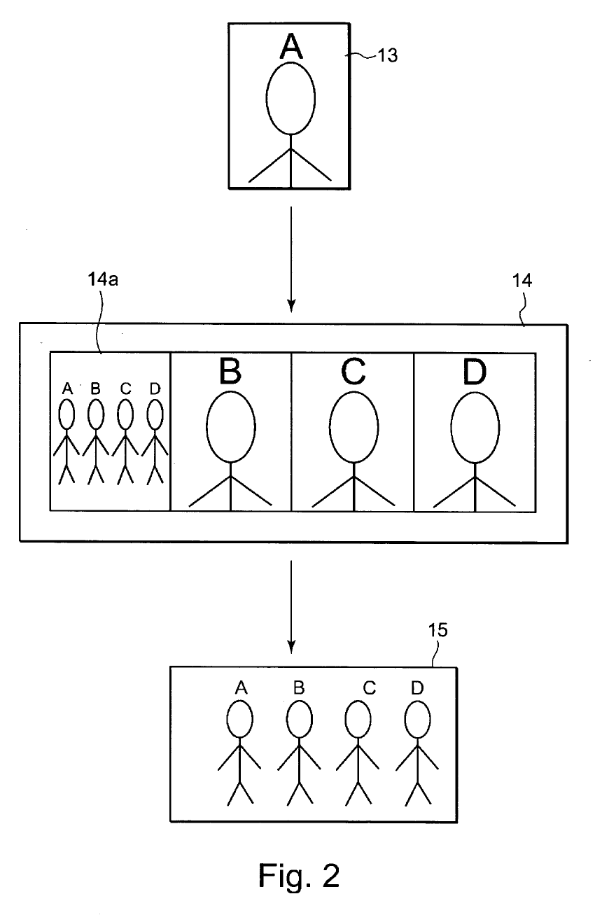

FIG. 2 is an explanatory view of a searching method based on the face index image.

When the user starts an image searching operation, in a display, a list of index images is displayed. At this time, in a case where the face index image is associated with the original image and stored, instead of the index image of the original image, there is displayed an face index image 13 of the person photographed in the original image. That is, in FIG. 1, the index image 10 is an index image of the original image in a state in which the plurality of persons gather together, but in FIG. 2, there is displayed the face index image 13 of the person A designated in FIG. 1.

When the user subjects this face index image 13 to a predetermined operation, an arrangement 14 of the face index images of the persons is displayed, with the proviso that in the arrangement 14 of the face index images, the image of the facial portion of the person A is not displayed, and instead an index image 14a of the original image is displayed.

When the user selects persons B, C and D, as described above, an original image 15 is displayed in which the corresponding person is positioned in the center. On the other hand, when the user selects the index image 14a of the original image from the arrangement 11 of the index images, as the original image 15, the original image (the extracted image 12 of FIG. 1) is displayed.

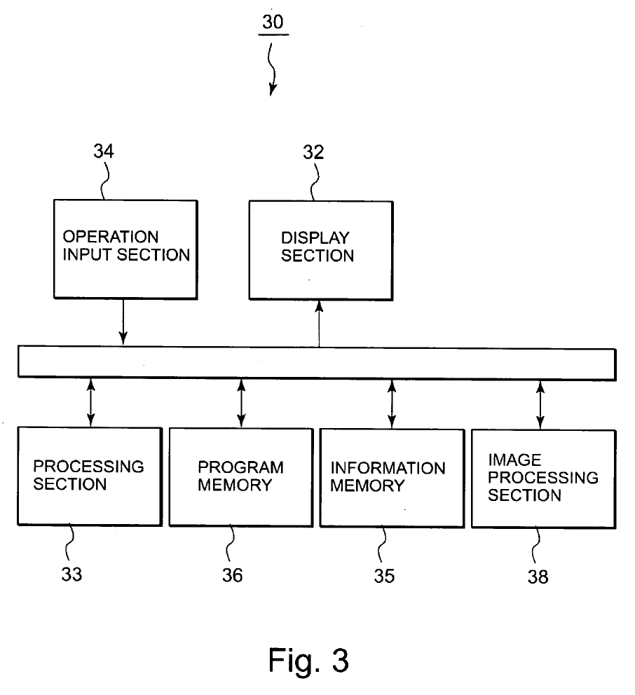

FIG. 3 is a block diagram showing a constitution of a searching device 30 for executing the above searching operation.

The searching device 30 includes a display section 32, a processing section 33, an operation input section 34, an information memory 35, a program memory 36, and an image processing section 38.

The display section 32 displays a list of index images, a searched original image and the like. The processing section 33 generally controls the sections of the searching device 30. The operation input section 34 is an input member which operates various functions of a mouse, a keyboard and the like to input an instruction.

The information memory 35 is a storage region for storing data and the like necessary for image searching, such as the original image, the index image of the original image, and a face index image. The program memory 36 is a recording medium which stores a program to be operated in the searching device 30. The image processing section 38 executes the present image search processing.

Subsequently, there will be described a searching operation using the searching device 30.

When the user starts the searching device 30, in the display section 32, a searching screen 1 is displayed.

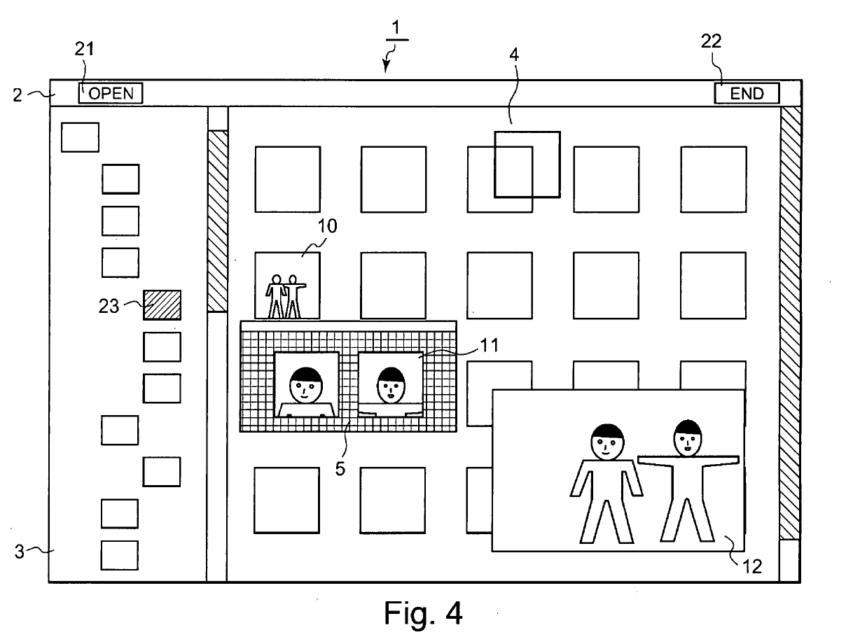

FIG. 4 is a diagram showing the searching screen 1. The searching screen 1 includes a tool bar area 2, a folder tree area 3, an image list area 4 and an extracted image list area 5.

The tool bar area 2 includes an open button 21 for designating an image file, and an end button 22 for ending the present processing. In the folder tree area 3, folder icons 23 are hierarchically displayed in a tree form. The image list area 4 displays the index image 10 of an image file included in a designated folder. In the extracted image list area 5, the arrangement 11 of the face index images is displayed.

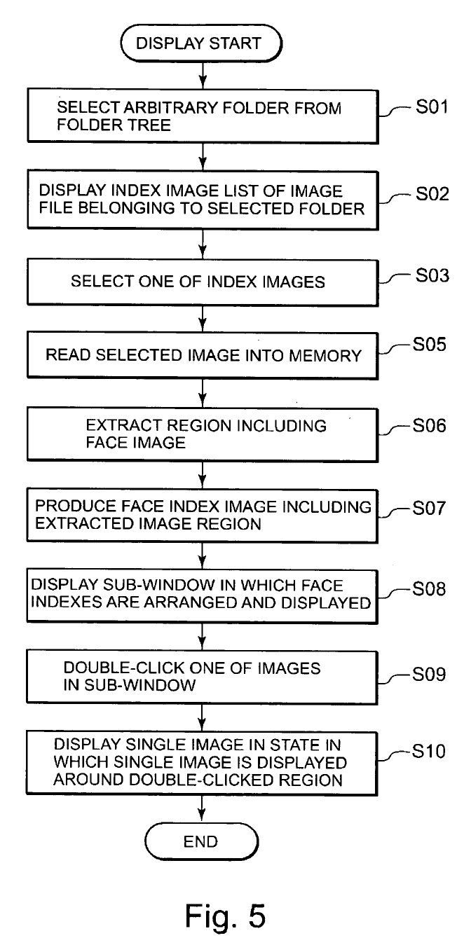

FIG. 5 is a flow chart showing a schematic procedure of search processing. It is to be noted that this processing realizes the function described with reference to FIG. 1.

When the user operates the open button 21, there are displayed, in the folder tree area 3, the folder icons 23 indicating the folders stored in the information memory 35 in which the images are stored.

In steps S01, S02, when the user selects one of the folder icons 23 displayed in the folder tree area 3 (image selecting function, image selecting step), index images 10 are produced which are reduced images of the original images stored as the image files in the selected folder (index producing function, index producing step). Moreover, the index images 10 are displayed in the image list area 4 (index display function, index display step).

When the user moves a mouse pointer onto a desired index image 10, in step S03, the index image 10 is brought into a selected state (index selecting function, index selecting step). Subsequently, processing to pick up the facial portion is started.

That is, in step S05, the original image corresponding to the selected index image 10 is read out, and in step S06, a region including the person's face is extracted (face extracting section, face extracting step). Moreover, in step S07, index images of the facial portion (face indexes) are produced from the extracted region (face index producing function, face index producing step). Moreover, in step S08, a list of produced face index images is displayed in the extracted image list area 5 which is a sub-window (face index display function, face index display step).

In step S09, when the user double-clicks one of the face index images displayed in the extracted image list area 5, the original image of the face index image is selected (second index selecting function, second index selecting step). In step S10, the facial portion is positioned in the center of the original image 12 to display the original image 12 (original image display function, original image display step).

Next, a variation of the present embodiment will be described. Here, the contents described with reference to FIG. 2 will be described in detail. The variation of the present embodiment is different from the above embodiment in that the variation includes a searching method in a case where already produced face index images are present. Therefore, the same parts as those of the above embodiment are denoted with the same reference numerals, and detailed description thereof is omitted.

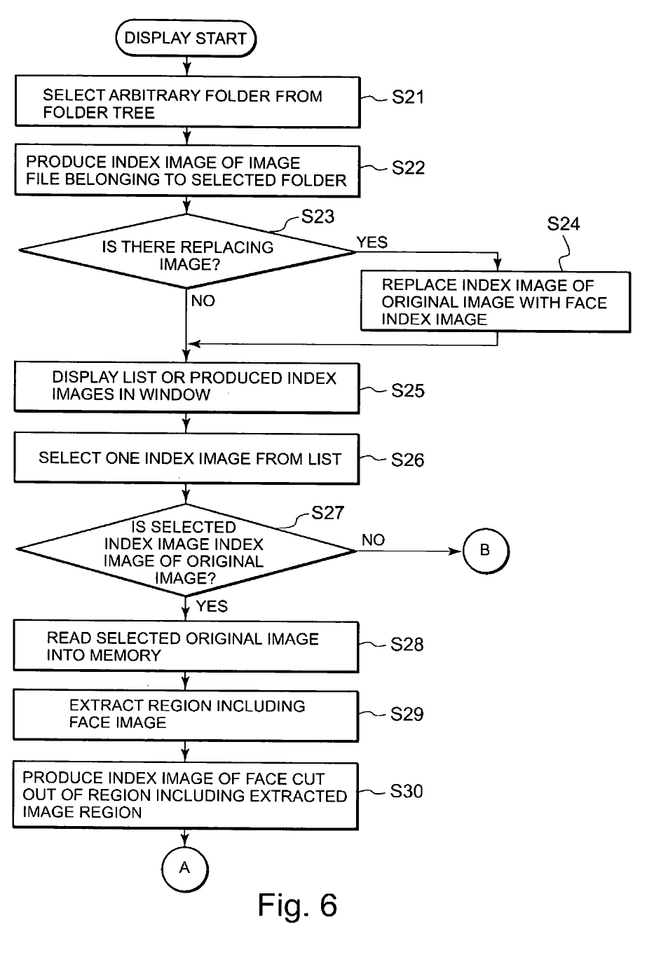

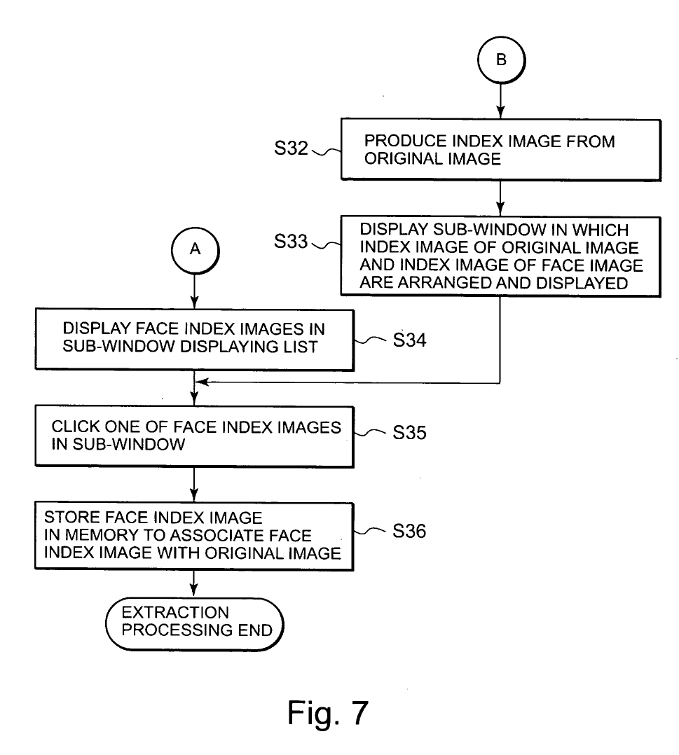

FIGS. 6, 7 are flow charts showing a schematic procedure of search processing in the variation.

When the user operates the open button 21, the folder icons 23 indicating folders stored in the information memory 35 in which the images are stored are displayed in the folder tree area 3.

In steps S21, S22, when the user selects one of the folder icons 23 displayed in the folder tree area 3, there are produced the index images 10 of the original images stored as image files in the selected folder.

At this time, it is checked in step S23 whether or not there are any replacing images, that is, any face index images already produced based on the image file is present. Moreover, in a case where the answer to the step S23 is yes, that is, there at least is a face index image, in step S24, the face index image designated beforehand replaces the corresponding index image 10 for displaying a list. In a case where there is no face index image, the index images 10 of the original image are to be displayed.

Moreover, in step S25, the produced index images 10 are displayed in the image list area 4.

When the user moves the mouse pointer onto a desired index image 10, in step S26, the index image 10 is brought into a selected state. Subsequently, it is checked in step S27 whether or not the selected index image is the index image of the original image. Moreover, in a case where the answer to the step S27 is yes, that is, the index image of the original image is selected, facial portion pickup processing is started.

That is, in step S28, the selected index image 10 is read into a memory, and the original image corresponding to the selected index image 10 is read out. In step S29, a region including the person's face is extracted. Moreover, in step S30, the face index image is produced from the extracted region. Furthermore, in step S34, the produced face index images are arranged and displayed in the extracted image list area 5 which is a sub-window.

On the other hand, in a case where the answer to the step S27 is no, in step S32, the index image of the original image is produced. Moreover, in step S33, there are arranged this index image of the original image, and the face index images other than the face index image already displayed in the image list area 4 to display the images in the extracted image list area 5 which is the sub-window. Moreover, in step S35, when the user clicks one of the face index images displayed in the extracted image list area 5, in step S36, the original image is displayed in a manner that the facial portion corresponding to the face index image is positioned in the center of the displayed image. Moreover, the face image is associated as a designated image with the original image and stored.

On the other hand, in the step S35, in a case where the user clicks a reduced image (the index image) of the original image, the original image is displayed.

It is to be noted that the operation input section 34 shown in FIG. 3 realizes the image selecting function, the index selecting function and the second index selecting function, and can be referred to as an image selecting section, an index selecting section and the second index selecting section. The processing section 33 realizes the index producing function, the index display function, the face extracting function, the face index producing function, the face index image display function and the original image display function, and can be referred to as an index producing section, an index display section, a face extracting section, a face index producing section, a face index display section and an original image display section.

It is to be noted that the index image of the face or the index image of the original image displayed in the extracted image list area 5 does not have to be the same as the index image displayed in the image list area 4. For example, a size of the index image displayed in the extracted image list area 5 may be set to be larger than that of the index image displayed in the image list area 4. The original image displayed by selecting the index image displayed in the extracted image list area 5 may be an image to be displayed which has been obtained by resizing the original image.

Furthermore, the functions described above in the embodiment may be constituted using hardware, or a program in which the functions are described using software may be read by a computer and realized. The functions may be constituted by appropriately selecting one of software and hardware.

In addition, the function may be realized by allowing the computer to read the program stored in a recording medium (not shown). Here, as to the recording medium of the present embodiment, there is not any restriction on a recording form as long as the program can be recorded, and the recording medium is computer-readable.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An image searching device comprising:
an image selecting section which selects at least one original image;
an index producing section which produces an index image of the original image selected by the image selecting section;
an index display section which displays the produced index image of the original image in a display;
an index selecting section which allows a user to select a desired index image from the index images displayed in the display;
a face extracting section which extracts a person's facial portion recorded in the original image corresponding to the index image selected by the index selecting section;
a face index producing section to produce a face index image which is the index image including the facial portion extracted by the face extracting section; and
a face index display section which displays in the display the face index image produced by the face index producing section.

2. The image searching device according to claim 1, wherein in a case where a plurality of persons are recorded in the original image, the face extracting section extracts the facial portions of the respective persons,
the face index producing section produces face index images from the plurality of extracted facial portions, and
the face index display section displays in the display the plurality of face index images produced by the face index producing section.

3. The image searching device according to claim 2, further comprising:
a second index selecting section which selects the face index image displayed in the display; and
an original image display section to display in the display an image in which an arrangement of the persons in the original image is changed so that the facial portion corresponding to the face index image selected by the second index selecting section is positioned in the center of the image.

4. The image searching device according to claim 1, further comprising:
an index information storage section which associates, with the original image, the index image and the face index image extracted from the original image corresponding to the index image to store the images,
wherein in a case where the face index image is associated with the original image corresponding to the index image, the index display section displays the face index image instead of the index image corresponding to the original image, and
in a case where a face index displayed in the display is selected, the face index display section displays the corresponding index image of the original image instead of the face index.

5. An image searching method comprising:
allowing a user to select at least one original image;
producing an index image of the original image selected by the image selecting step;
displaying in a display the produced index image of the original image;
allowing the user to select a desired index image from the index images displayed in the display;
extracting a person's facial portion recorded in the original image corresponding to the selected index image;
producing a face index image which is the index image including the extracted facial portion; and
displaying in the display the produced face index image.

6. A recording medium in which an image searching program is recorded, the program:
allowing a user to select at least one original image;
producing an index image of the selected original image;
displaying in a display the produced index image of the original image;
allowing the user to select a desired index image from the index images displayed in the display;
extracting a person's facial portion recorded in the original image corresponding to the selected index image;
producing a face index image which is the index image including the extracted facial portion; and
displaying in the display the produced face index image.
